(19) United States
(12) Patent Application Publication
(10) Pub. No.: US 2008/0200853 A1
(43) Pub. Date: Aug. 21, 2008

(54) Physical Therapy Apparatus for Self-Administered Soft Tissue Manipulation

(76) Inventor: Frank Tielve, Toronto (CA)

Correspondence Address: RICHES, MCKENZIE & HERBERT, LLP, SUITE 1800, 2 BLOOR STREET EAST, TORONTO, ON, M4W 3J5, omitted

(21) Appl. No.: 11/885,277

(22) PCT Filed: Mar. 10, 2006
(86) PCT No.: PCT/CA06/00369

§ 371 Date: Aug. 29, 2007

(30) Foreign Application Priority Data
Mar. 17, 2005 (CA) 2.501,152

(51) Int. Cl. A61H 7/00; A41F 3/02

(52) U.S. Cl. 601/134; 2/338

(57) ABSTRACT

An apparatus for performing soft-tissue manipulation of a user's spinal discs, and other back, neck and glutei soft-tissues includes a rigid or semi-rigid working member having at least one operational side surface for engaging contact with target soft-tissues and to which are secured a pair of straps. The operational side surface is provided with design form features configured to produce a therapeutic effect on the target soft-tissues when in contact therewith, and which may include recesses, projections or other protuberances. The working member and straps have an overall longitudinal length selected to enable the apparatus to be positioned partially encircling a user's body with the straps secured to a support. The length enables the user to stand or sit in a rearward inclined position, leaning backwardly to effect relative bearing contact between the target soft-tissues and the operational surface of the working member.

### SCOPE OF THE INVENTION

The present invention relates to a physical therapy apparatus which is adapted to permit a user to manipulate his or her spinal discs, muscles and/or connective tissues, and more preferably an apparatus which includes a working element having one or more operational side surfaces which operates with the assistance of the user's body weight and motion to permit enhanced manipulation of a user's spinal discs, back, neck and hip region muscles and connective tissues.

### BACKGROUND OF THE INVENTION

During the early years of life, humans are highly flexible, energetic and essentially healthy and pain-free. As individuals age, there is typically a gradual loss of flexibility, a reduction of energy levels, and the appearance of an increasing number of physical symptom ailments. A primary reason that an increasing number of symptom ailments are experienced with the passage of time is not that they are necessarily caused by an aging process, rather, bad posture and poor body mechanics used in the performance of ordinary daily activities, combined with increasingly sedentary life styles typically lead to damaged spinal discs. Most frequently the lower-lumbar region discs are the first to be affected. Even minor spinal disc damage caused by overstretching and tearing of the disc's inner annular rings, if not recognized and effectively treated may act as a catalyst, causing a gradual chain reaction of contracting muscles and stressed connective tissues starting in the area of the damaged discs, and gradually spreading throughout the entire body. Chronic abnormal muscle tissue contraction will cause excessive connective tissue tension and excessive wear and tear of body joints, osteoarthritis and hip and knee joint damage are typical outcomes. Also, abnormal chronic muscle tissue contraction can exert excessive pressure on various vital body systems, and indirectly cause a great many dysfunctions. For example, chronic muscle contraction can apply excessive pressure to nerves, blood vessels and lymphatic vessels triggering many symptom ailments. Symptom ailments that are typically caused by the said disc damage directly or indirectly include in part: back pain, sciatica, fibromyalgia, tension myositis syndrome, spinal stenosis, pinched spinal nerves, facet joint syndrome, spondylolisthesis, mild scoliosis, tendonitis, coccydynia, temporomandibular joint syndrome, muscle tissue inflammation, abdominal pain, chronic constipation, urinary tract dysfunction, tension headaches, excessive hair loss, vision impairment, hemorrhoids, varicose veins, reproductive tract dysfunction, intense PMS symptoms, sleep disorders, abdominal bloating, excess gas, stomach acid reflux, circulatory deficiency, elevated blood pressure, sinus congestion, neck pain, respiratory deficiency and stress symptoms. The reduced flexibility caused by chronic muscle tissue contraction and connective tissue stress also places sufferers at a higher risk of torn tissues as a result of heavy exertion, or as a result of impact injuries as may occur in an automobile accident, or a fall.

Presently, muscular massage is commonly used to treat symptomatic muscular ailments by providing muscular massage. U.S. Pat. No. 5,935,090 to Kennon and U.S. Pat. No. 5,683,352 to Watts each describe conventional massaging apparatus which are commonly used. Conventional massaging apparatus typically consist of a U-shaped or hooked member which is provided with a handle at one or both ends, and which includes a cylindrical projection. In use, the apparatus is held by gripping the handle, and then manually pulling the projection against the user's back muscles to apply a desired degree of contact pressure thereto. Conventional massaging apparatus suffer a disadvantage in that their structure and use, contact pressure between the appliance projection and the user's back muscles is dictated solely by the force of the user manually pulling the projection into engaging contact with the muscles to be treated. Heretofore, such conventional massaging apparatus have not achieved wide commercial popularity as the manual pressure applied by the projection is frequently insufficient to provide a significant therapeutic benefit. Furthermore, because such devices operate by the manual application of pressure resulting by the user's arm extensions, conventional massaging apparatus may disadvantageously result in increased fatigue and/or strain to the user's arm, Teres Major muscles and/or other muscle groups, resulting in an overall negative therapeutic benefit. In addition, none of the previous massaging apparatus have the ability to effectively treat the internal spinal disc damage that is the root cause of the muscle contraction, connective tissue stress, and the resulting many symptom ailments. Conventional treatment of the symptom ailments directly is ineffective since their elimination can only be achieved by the effective treatment of their true root-cause which is very often in an entirely different location.

### SUMMARY OF THE INVENTION

The applicant has appreciated that for optimum effectiveness, any physical therapy treatment preferably provides a sufficient range of spinal disc, and muscular and/or connective tissue deflection or movement to achieve the recentering of spinal disc cores, a reversal of abnormal muscle contraction, and release of abnormal connective tissue stress. Regular use of such apparatus combined with the adoption of good posture and body mechanics will facilitate healing of internal disc tissues and prevent future spinal disc damage and the inevitable consequences.

Accordingly, the present invention seeks to at least partially overcome some of the disadvantages associated with prior art massaging devices by providing a physical therapy apparatus which is adapted to permit the self-administration of more robust and effective forces to a user's spinal discs, and neck, back, and hip region muscles, tendons, ligaments and fascia hereinafter referred to as soft tissues.

In a most simplified construction, the physical therapy apparatus includes a working member having at least one soft tissue engaging operational surface, and one or more attachment belts or straps used to couple the apparatus to a support. The belts or straps have an overall length chosen to permit the user to stand or sit in a position at least partially encircled by the apparatus and lean away from the support to effect therapeutic contact between the operational working surface and a target tissue to be manipulated. Preferably, contact pressure between the user's soft tissues and operational working surfaces is achieved at least in part by the user's own weight and the assistance of gravity, with the user standing or seating in a rearward leaning position facing the support, in such positions, the user's own weight may provide comparatively more robust relative contact force between the apparatus and the user's soft tissues.

It is another object of the invention to provide an apparatus which can be used to self administer physical therapy to spinal discs, and to a variety of soft tissues of the neck, back and hip regions in a systematic manner, targeting the root cause of the symptom ailments, not the symptom ailments themselves. These soft tissues include in part the: abdominal transverse, cervical interspinal, cervical selenium, cervical rotary, cervical posterior intertransverse, dorsal erector, deep thoracolumbar fascia, deltoid, external intercostals, external abdominal oblique, greater trochanter, gluteus medius, gluteus maximus, gluteus minimus, intertransverse thoraxic, internal intercostals, intestinal lumbar, inferior gemellus, iliocostalis, inferior oblique of the head, internal abdominal oblique, internal obturator, infraspinatus, long rib elevator, latissimus dorsi, lumbocoastal ligaments, lumbar rotator, lumbar quadrate, lumbar triangle, lateral intertransverse lumbar, lentissimo capitis, lentissimo dorsali, lumbar coastal ligament, levator scapulae, musculus multifidus, medial intertrasversal lumbar, minor rectus posterior capitis, major rectus posterior capitis, major dorsal, major round, minor round, nuchal ligament, obliquus capitis superior, obliquus capitis inferior, obturator internus, piriformis, posterior serratus, quadratus lumbonum, quadratus femoris, rib short elevator, rectus capitis posterior minor, rectus capitis posterior major, rotator of the thorax, rhomboidus minor, rhomboidus major, small posterior of the head, superior oblique of the head, semispinal of the head, senispinalis capitis, splenius capitis, splenius cervicis, spinalis, serratis inferior posterior, serratis superior posterior, serratis anterior, spinal of the thorax, supraspinatus, surraspinatus, superior gemellus, stemocleidomastoid, trapezoid, thoracolumbar fascia, terns major, tensor fasciae latae.

Another object of the invention is to provide an apparatus that can utilize the force of gravity to perform the work required for a more enhanced soft tissue manipulation than compared to conventional handheld devices, therefore allowing the user to more fully relax and/or move the tissues being treated.

A further object of the invention is to provide a physical therapy apparatus for manipulating soft tissues which permits the manipulation of back, neck and hip region soft-tissues in a more at rest initial orientation, and thereafter which are moved through their working range, while a selected amount of pressure is exerted by the apparatus.

Another object of the invention is to provide an apparatus that incorporates one ore more working surfaces having a number of different design form features that allow for therapeutic interaction between the form features and different anatomical structures.

A further object of the invention is to provide an apparatus that can be operated by the user essentially hands-free while sitting or standing.

Yet another object of the invention is to provide an apparatus for the self-administration of massage and/or physical therapy that is light weight, economical to produce and highly portable.

Another object of the invention is to provide an exercise or physical therapy apparatus for manipulating a user's back soft-tissues and which includes an elongated working member having at least one muscle engaging working side which is provided with a pair of spaced protuberances adapted to simultaneously engage back and neck soft-tissues on immediately opposing sides of the user's spinal column.

A further object of the invention is to provide an apparatus for performing soft-tissue manipulation on a user's back, neck and glutei region soft-tissues, and which includes a generally rigid elongated working member, and an elongated strap coupled at one and more preferably at each end thereof. The straps are adapted to either permanently or temporarily secure the apparatus to a support structure selected to support the weight of a user standing in either a substantially upright or inclined position generally leaning away from the support so as to effect a desired degree of contact pressure between the user's soft-tissues and the working member.

To at least partially achieve some of the aforementioned objects, the present invention resides in an apparatus for performing manipulation of a user's spinal discs, and more preferably one or more of the user's back, neck and glutei region soft-tissues. The apparatus includes a rigid or semi-rigid working member which is generally elongated and which has at least one operational side surface which is adapted to be brought into engaging contact with the soft-tissues to be treated. The operational side surface is provided with design form features which are configured to produce a therapeutic effect on various soft-tissues and/or anatomical structures when such contact occurs, and which, for example, may include recesses, projections or other protuberances which are chosen having regard to a specific target soft-tissue to be treated.

The working member and the straps or belt-like members coupled thereto have an overall longitudinal length which is selected to enable the apparatus to be positioned at least partially encircling the user's body with the ends of the straps to be secured to a support. Preferably, the apparatus has an overall longitudinal length selected at between about 0.75 and 4 meters, and more preferably about 1 and 3 meters. This length enables the user to stand in a generally rearward inclined position, wherein the user leans backwardly in a direction away from the support to effect relative bearing contact between the user's soft-tissues, such as the back and glutei muscles, and an operational surface of the working member.

The straps used in coupling the apparatus to the support preferably permit manipulation of the apparatus during use, and may act as handles. More preferably, the straps or belt-like members are each formed having a semi-rigid portion which is either coupled to or integrally formed with a respective end portion of the working member, and to which are secured flexible plastic, fabric, Nylon or other suitable webbing or strap ends. The flexible strap ends which may be used to attach the apparatus to the support are selected to safely withstand the substantial pressures generated during use. The semi-rigid portions are preferably formed having a rigidity which is selected to enable the user to reposition the working member vertically relative to the user's back, neck and glutei soft-tissues, by applying a manual upward or downward pressure thereon. In a further possible construction, the flexible strap ends may be configured for coupling the apparatus about a door as the apparatus support. In such a construction, the flexible strap ends have a thickness selected to permit their placement between the door and an adjacent doorjamb when fully closed. Alternately, two or more apparatus can be connected to each other for use simultaneously by two or more individuals, without the need of a fixed weight supporting structure.

Preferably, the first operational surface includes a design form feature for manipulating back and neck soft-tissues which includes a pair of protuberances which extend laterally outwardly from a remainder of the surface, to a respective distalmost contact surface. The protrusions are located so that the contact surfaces are displaced longitudinally along a longitudinal length of the working member. More preferably, the protrusions are spaced between 0.5 and 5 cm from a lateral center of the working member midway between its ends.

Although not essential, the apparatus may also be provided with two or more operational surfaces having different form features for manipulating different soft-tissues. Optionally, in addition to protuberances, the first operational surface may also be provided with concave portions for use in providing soft-tissue manipulation of the user's back and neck regions. The concave portions are preferably positioned between each protuberance and the proximate-most end of the working member. Alternately, a second operational side surface of the working member may include a concave recess or one or more of laterally projecting bosses for providing manipulation of the user's back, neck and glutei region soft-tissues.

The apparatus support most preferably is chosen so that when the apparatus is coupled thereto, the ends of the straps spaced furthest from the working member are movable in a vertical path approximately 0.75 to 2.5 meters above the floor. It is to be appreciated that with this construction, the straps or belt-like members are used to secure the working member to the support generally at or above the user's waist. This configuration is optimum in enabling the user to stand or sit in the rearwardly inclined position, maximizing the application of his or her body weight directly against the operational side surfaces and form features of the working member. It is to be appreciated that such use achieves greater contact pressures between the operational surface and the user's soft-tissues, than that provided by conventional hand-held massage appliances.

In an alternate possible construction, the apparatus may include an attachment member which is constructed to enable the releasable attachment of a selected one of a number of modular working members to the strap members. In such a construction the modular working members may be provided for selective attachment to or detachment from the strap members in substitution, depending on the target soft-tissues to be treated. Such modular working members are respectively provided with operational surfaces adapted to perform manipulation of the user's back, neck and glutei regions.

In use, the apparatus is positioned so that a design form or forms is in contact with or near a target soft-tissue to be treated. Most preferably, such soft-tissue contact is performed while tissues are in a mostly relaxed state, and a selected pressure is applied by the form features by using primarily the force of gravity. In this manner, the target soft-tissues may be manipulated so as to move through their normal operating range. In one preferred method, spinal discs are treated by positioning a working member against the area of the spine to be treated, so that the working member engages soft-tissues immediately adjacent the user's spinal column. The user thereafter arches his or her spine backwards against the contact surface as much as possible, inducing a high pressure on the posterior side of the discs, and a low pressure on the anterior side. As a result, the disc nucleuses are forced to slowly move towards the anterior side, reducing and eventually eliminating spinal disc bulges. When disc cores are centered, healing of internal disc tissue damage is facilitated.

In a similar manner, an appropriate working member may be placed on the buttock region to treat the user's glutei tissues. With the user's leg on the same side being relaxed and not bearing any substantial body weight, the user leans back against the contact surface of the device so as to apply the desired pressure. For a more intense treatment, after pressure is applied to the glutei tissues, the leg on the same side is moved through its natural motion ranges.

Accordingly, in one aspect the present invention resides in an apparatus for performing soft-tissue manipulation of a user's back and neck regions, the apparatus comprising,

a generally elongated working member extending from a first end portion to a second end portion and including a first longitudinally elongated surface, the first surface including first and second protuberances, each of said protuberances extending a first lateral direction from a remainder of said first surface, to a respective distal-most contact surface, the contact surfaces each being longitudinally spaced from a center of said member by a distance selected at between about 0.5 and 5 cm,

a pair of longitudinally elongated strap members, each said strap member having a first end coupled towards an associated one of said first and second end portions, and a second end adapted for coupling said apparatus to a support,

said working member and said strap members having an overall longitudinal length selected to permit said user to effect relative contacting movement between said user's soft tissues and the contact surface of said first and second protuberances, with said second ends of said strap members coupled to said support and said user standing in a generally rearwardly inclined position leaning in a direction away from said support.

In another aspect, the present invention resides in a physical therapy apparatus for performing manipulation of a user's back and neck soft-tissues, the apparatus containing,

a working member comprising a generally elongated member body extending from a first end portion to a second end portion, the body including,
a first operational side including first and second protuberances, each of said protuberances extending laterally outwardly from a remainder said first side to a respective distal-most contact surface, the contact surfaces being spaced from each other and a center portion of said body by a distance selected at between about 1 and 7.5 cm,
a second operational side including a boss, the boss being spaced towards said center portion and extending laterally outwardly from a remainder of said second side to a distal-most end,

first and second strap members, each of said strap members having a first end coupled towards an associated one of said first and second end portions, and a second end adapted for coupling said apparatus to an apparatus support, said working member and said first and second strap members having an overall length selected to permit said user to stand or sit in a generally rearwardly inclined position leaning in a direction away from said support and effect relative sliding contact between said user's back and neck soft-tissues and said body when the second ends of the strap members are coupled to said support.

In a further aspect, the present invention resides in a physical therapy apparatus for manipulating a user's back and neck soft-tissues, the apparatus comprising,

a working member comprising a generally elongated member body extending from a first end portion to a second end portion, the body including,
a first operational side including first and second protuberances, each of said protuberances extending in laterally outwardly from a remainder said first side to a respective distal-most contact surface, the contact surfaces comprising a laterally elongated surface and being spaced from each other and a center portion of said body by a distance selected at between about 1 and 7.5 cm,
said first operational side further comprising a pair of generally concave portions, each of said concave portions interposed between a respective one of said first and second protuberances and said first and second end portions,
a second operational side including a boss, the boss being spaced towards said center portion and extending laterally outwardly from a remainder of said second side to a distal-most end, said distal-most end comprising semi-spherical surface and further includes a resiliently deformable elastomeric layer,

first and second strap members, each of said strap members having a first end coupled towards an associated one of said first and second end portions, and a second end adapted for coupling said apparatus to an apparatus support, said working member and said first and second strap members having an overall length selected to permit said user to stand or sit in a generally rearwardly inclined position leaning in a direction away from said support and effect relative sliding contact between said user's back and neck soft-tissues and said body when the second ends of the strap members are coupled to said support.

### BRIEF DESCRIPTION OF THE DRAWINGS

Reference is now made to the following detailed description taken together with the accompanying drawings in which:

FIG. 1 shows a perspective view of a physical therapy apparatus for providing the self-administered manipulation of a user's soft-tissues in accordance with a preferred embodiment of the invention;

FIG. 2 shows a schematic top view of a working member used in the physical therapy apparatus of FIG. 1;

FIG. 3 shows a front perspective view of a first operational side surface of the working member of FIG. 2;

FIG. 4 shows a back schematic view of a second operational side surface of the working member of FIG. 2;

FIG. 5 shows a cross-sectional end view of the working member of FIG. 2 taken along lines 5-5′;

FIG. 6 shows a perspective view of the physical therapy apparatus of FIG. 1 in use secured to a door;

FIG. 7 shows a perspective view of a physical therapy apparatus in accordance with the second embodiment of the invention in use, with each end respectively secured to a permanent wall mounted metal support channel;

FIG. 8 shows a cross-sectional view of the support channel/apparatus coupling used in the securement of each end of the physical therapy apparatus of FIG. 7, taken along line 8-8′;

FIG. 9 shows a physical therapy apparatus mounted in a wall cabinet in accordance with a further embodiment of the invention;

FIG. 10 shows the mounting brackets used in the installation of FIG. 9;

FIG. 11 shows the operation of the physical therapy apparatus of FIG. 1 in accordance with a further embodiment of the invention; and

FIG. 12 shows a perspective view of a physical therapy apparatus incorporating interchangeable modular working members in accordance with a further embodiment of the invention.

### DETAILED DESCRIPTION OF THE PREFERRED EMBODIMENTS

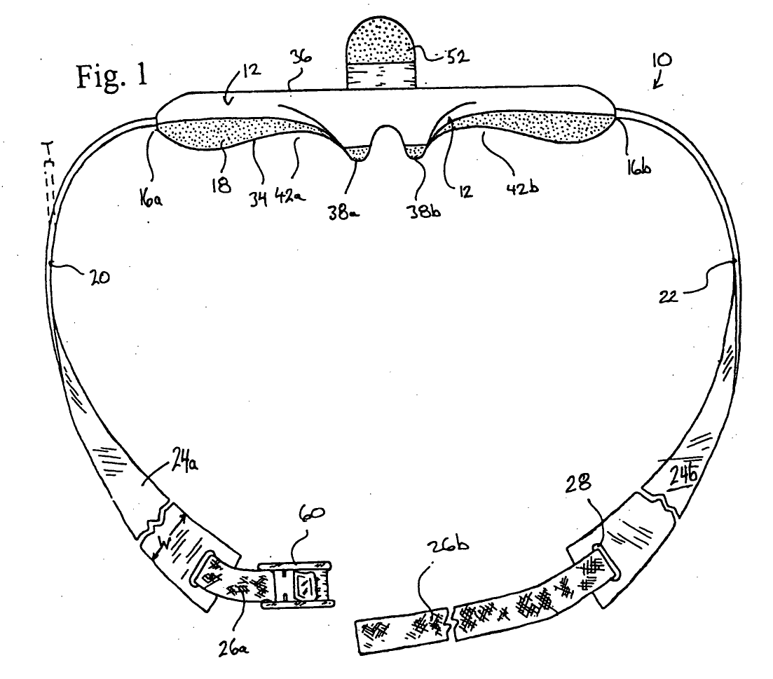

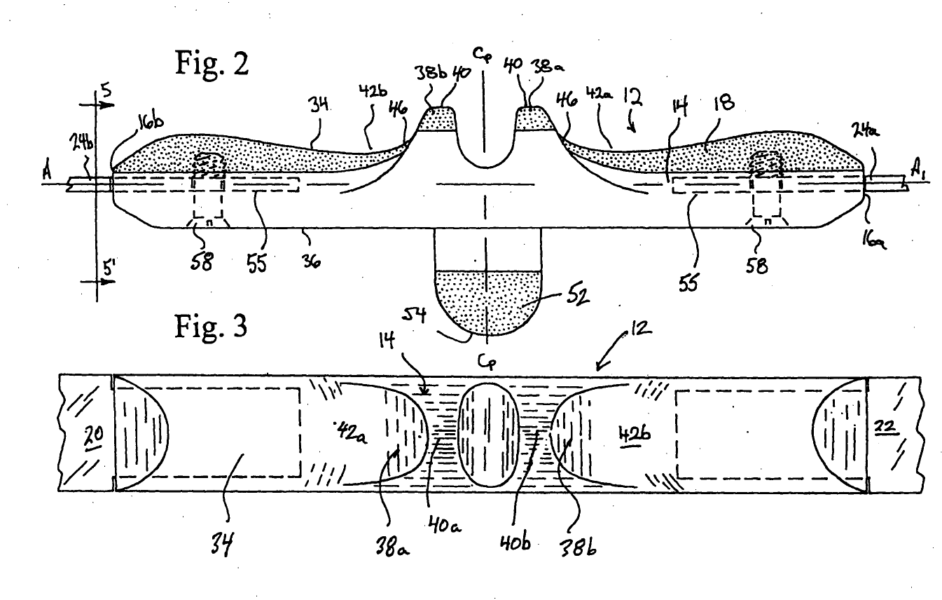

Reference is first made to FIG. 1 which shows a physical therapy apparatus 10 for self-administered manipulation of a user's back, neck and glutei region soft-tissues in accordance with a preferred embodiment of the invention. The apparatus 10 is generally elongated having an overall longitudinal length of between about 1 and 4 meters and more preferably about 1.5 to 2.5 meters. The apparatus 10 includes a centrally disposed working member 12 and a pair of longitudinally extending strap members 20, 22, which, as will be described, extend from each longitudinal end 16a, 16b thereof. FIG. 2 shows best the working member 12 including a generally rigid plastic core 14 over which at least partially applied is an elastomeric coating 18. The working member 12 is longitudinally elongated along axis A-A₁ from the first longitudinal end 16a, to the end 16b remote therefrom, and further includes two opposite longitudinally extending operational side surfaces 34, 36. As will be described, the side surfaces 34, 36 are adapted to engage and manipulate soft-tissues of the user's back, neck and glutei such as back muscles, Latissimus Dorsi and glutei muscles, respectively.

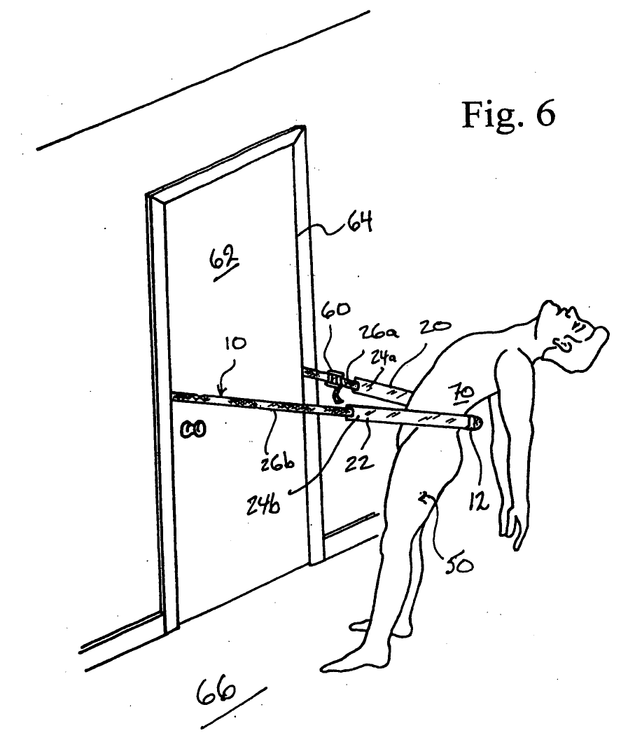

The first working member's operational side surface 34, is shown best in FIGS. 2 and 3 as including as form features a pair of protuberances 38a, 38b, and a pair of concave. depressions 42a, 42b. The protuberances 38a, 38b and depressions 42a, 42b are spaced symmetrically in a mirror configuration on each side of the center plane Cp-Cp (FIG. 2) of the member 12 located midway between the ends 16a, 16b. The protuberances 38a, 38b are spaced from each other by a longitudinal distance of approximately 1 to 5 cm, and extend laterally a distance of about 1 to 4 cm from the remainder of the first operational side surface 34 to a respective distalmost contact surface 40a, 40b (FIG. 3). Although not essential, most preferably, the contact surfaces 40a, 40b are generally semi-cylindrical in shape, curving laterally outwardly from each longitudinal side of the working member 12. It is to be appreciated that the longitudinal spacing between the protuberances 38a, 38b is selected to permit placement of the contact surfaces 40a, 40b against soft-tissues on immediately adjacent sides of the spine of a user 50 (FIG. 6).

FIG. 2 shows best the longitudinally elongated concave depressions 42a, 42b. The concave depressions 42a, 42b are spaced respectively, between each protuberance 38a, 38b and an adjacentmost member end 16a, 16b. The depressions 42a, 42b are formed having a radius of curvature of at least 10 cm and which merge with a curving sidewall 46 of each protuberance 38a, 38b. More preferably, the radius of curvature of the depressions 42a, 42b is selected to substantially approximate the curvature of the user's torso 70 (FIG. 6).

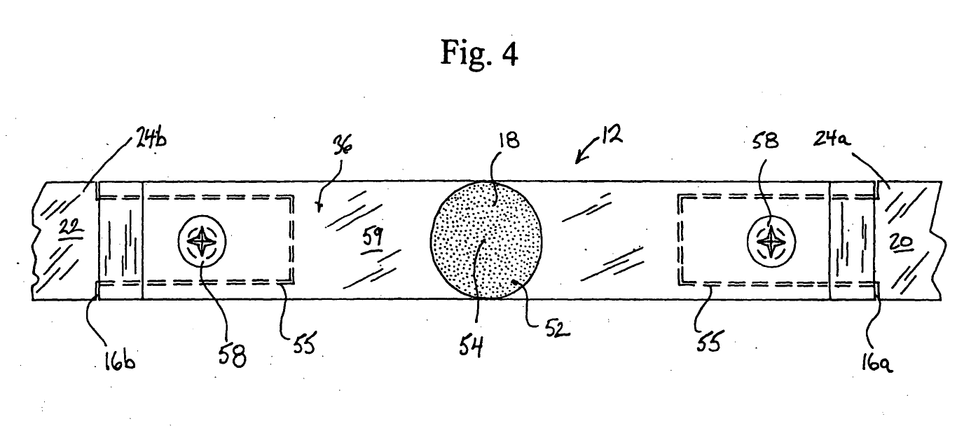

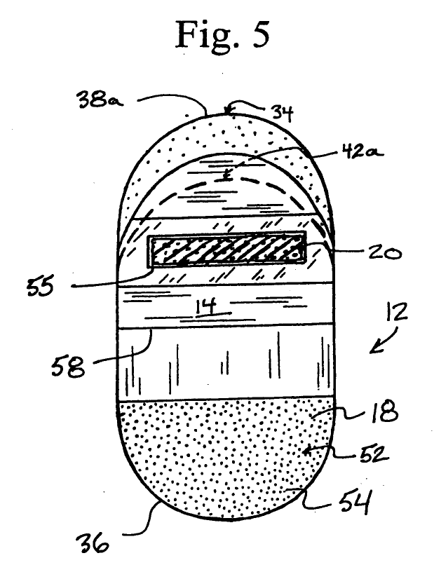

FIGS. 2, 4 and 5 show best the second operational side surface 36 of the working member 12. As will be described, the operational side surface 36 is used in providing soft-tissue manipulation of the user's glutei region soft-tissues. The second operational surface 36 includes a boss 52 which extends laterally outward from a generally planar remainder portion 59 of the side surface 36, in a direction opposite to the direction of extent of the protuberances 38a, 38b. The boss 52 is most preferably aligned with the center plane Cp-Cp FIG. 2) of the working member 12 and terminates in an outwardmost semi-spherical contact surface 54. The contact surface 54 has a radius curvature selected at between about 2 and 10 cm.

Although not essential, an elastomeric coating 18 is most preferably applied over the body 14 so as to extend over at least each of the protuberances 38a, 38b, the concave depressions 42a, 44a and the contact surface 54 of the boss 52. In an alternate construction, the coating 32 may be provided over substantially the entire member body 14, and formed as a rubber coating having an average thickness of between about 1 and 10 mm.

FIG. 1 shows both strap members 20, 22 as including respectively a semi-rigid proximal portion 24a, 24b and a distalmost flexible web end portion 26a, 26b. Each of the semi-rigid proximal portions 24a, 24b are coupled to a respective working member body end 16a, 16b. FIG. 2 shows best the distal end of each semi-rigid portion 24a, 24b being secured within a respective end slot 55 formed in each member end 16a, 16b. Threaded fasteners 58 are insertable laterally through the working member body 14 so as to releasably engage the ends of the semi-rigid portions 24a, 24b located within the slots 55, to releasably physically couple the strap members 20, 22 to the working member body 14.

The semi-rigid portions 24a, 24b are formed from Nylon or other suitable plastic. Most preferably, the semi-rigid portions 24a, 24b are provided with a generally elongated rectangular shape, having a thickness T (FIG. 1) which is selected at between about 0.4 and 1.5 cm, and a lateral width W of between about 2 and 12 cm. The construction of the semi-rigid portions 24a, 24b enables bending across their lateral width W so as to permit at least some limited curvature about the upper torso 70 of the user 50 (FIG. 6), while providing each portion 24a, 24b with a rigidity against bending forces normal to their edge portions.

Each of the flexible web ends 26a, 26b are shown best in FIG. 1 and being secured at one end in a slot 28 formed towards the distalmost end of the semi-rigid portion 24a, 24b. As will be described, the flexible web ends 26a, 26b are generally planar and have a thickness which is preferably selected to permit positioning between a door 62 (FIG. 6) and the adjacent doorjamb 64 when the door 62 is fully closed. Although not essential, more preferably the thickness of the web ends 26a, 26b is chosen to permit at least some limited vertical sliding movement of the web ends 26a, 26b between the door 62 and the doorjamb 64. Alternatively, pads of non-slip material may be provided to the flexible web positioned so that they are forcefully squeezed when the door is closed, therefore preventing any sliding motion of the flexible web.

FIG. 1 shows best the web portion 26a as further including a steel buckle clip 60. As will be described, the clip 60 is used to selectively couple the distalmost end of the flexible web 26a to the distalmost end of the flexible web 26b in the use and operation of the physical therapy apparatus 10. The strap members 20, 22 may be the same or of different lengths, with each strap having an overall length selected at between about 10 cm and 3 meters, depending on the overall desired length of apparatus 10.

Reference is made to FIG. 6 which shows the user 50 in use of the apparatus 10 of FIGS. 1 to 5. Initially, the flexible web end 26b is looped around a door 62 with the web end 26b positioned on each vertical side of the door 62 between the door and the doorjamb 64. The clip 60 is then used to couple the web end 26a to the web end 26b, thereby releasably securing the apparatus 10 to the door 62 as a support. Preferably, flexible web 26a is kept relatively short about 10 cm in order to place the locking and adjustment clip 60 within easy reach of the user 50 when used in conjunction with a door. Preferably, the strap members 20, 22 are coupled to the door 62 at a minimum height of between about 0.4 and 2 meters above the floor 66, and more preferably at a height between the user's waist and shoulders.

With the apparatus 10 so secured, the user 50 assumes a standing or sitting position facing the door 62, and with the working member 12 located behind the user 50 so that he or she is substantially encircled by the apparatus 10. The user 50 then grips the semi-rigid portions 24a, 24b of the strap members 20, 22 to position a selected operational side surface 34, 36 (FIG. 1) in bearing contact against the target neck, back, and/or glutei tissues (lower back muscles shown in FIG. 6) to be manipulated with the semi-rigid strap portions 24a, 24b extending along the sides of the user's torso 70.

In a most preferred physical therapy regime, in initial use the first operational side surface 34 is brought into contact against the user's back soft-tissues so that the distal contact surface 40 of each of the protuberance 38a, 38b engages soft-tissues on immediately opposing sides of the base of the user's spine. To achieve the desired degree of soft-tissue manipulation, the user 50 stands or sits in the position shown in FIG. 6, leaning backward so as to incline his or her body away from the door 62 and bringing his or her body weight against the working member 12. As a result, the weight of the user 50 assisted by gravity, effects engaging contact between the protuberances 38a, 38b and the user's back soft-tissues with greater contact pressures than could be achieved solely by the user 50 pulling the massage apparatus 10 against his back. Concurrently therewith, the operational side surface 34 is slid both vertically relative to the spine and laterally by the user 50 gripping the semi-rigid strap portions 24a, 24b of the straps 20, 22 and applying an upward or downward lateral pressure thereon. The user 50 begins at the base of the spine and slides the operational surface 34 upwardly therealong. Most preferably, the back and neck soft-tissues are manipulated by the engaging contact between the protuberances 38a, 38b along substantially the entire length of the spine from the lower sacral to the base of the skull. Because of the inclined position of the user 50, soft-tissue manipulation occurs while the back and neck soft-tissues are at least partially at rest. The greater contact pressures and range of motion of the spine achieved permit a greater degree of movement of the spinal discs, as well as their enhanced realignment anteriorally.

To achieve manipulation of other back and neck soft-tissues, the user 50 rotates his or her torso or neck 70 so that a concave depression 42a, 42b is respectively moved along each side of the torso or neck 70 and into contact with the various soft-tissues. The user 50 similarly provides contact pressure between the operational side surface 34 and soft-tissues by leaning his or her body weight against the working member 12 while moving the surface 34 vertically relative to the torso 70 or neck.

In a second possible mode of operation, to exert a selected degree of pressure, the user 50 moves his or her spine from the normal upright standing position to the rearwardly inclined position to provide a maximum backward arch to the spine as possible. Once so positioned, the user 50 rotates his or her torso 70 to the right and left sides, with the operational side surface 34 in contact thereagainst, and the spine occasionally arched forward. The procedure may be repeated a number of times, with the apparatus 10 moved vertically relative to the spine about one inch up or down the spine and the procedure is repeated.

Following completion of back and neck soft-tissue manipulation, the apparatus 10 is flipped 180° so that second operational side surface 36 and boss 52 are oriented forwardly facing the user's back and door 62. The user 50 then reassumes the rearwardly inclined position so that the semi-spherical contact surface 54 is brought into engagement with the soft-tissue of the user's leg and/or glutei to provide the desired degree of soft-tissue manipulation. The leg is then moved up and down, inward and outward so as to manipulate the buttock soft-tissues increasing flexibility, and enhancing blood flow thereto. The pressure exerted by the apparatus is proportional to the angle of the body relative to the apparatus, the greater the angle of the body, the greater the pressure exerted. Pressure greater than gravity can be easily applied by the user further using his or her hands to apply a forward and/or downward pressure on the flexible belt-like handles, or by pressing against the support structure.

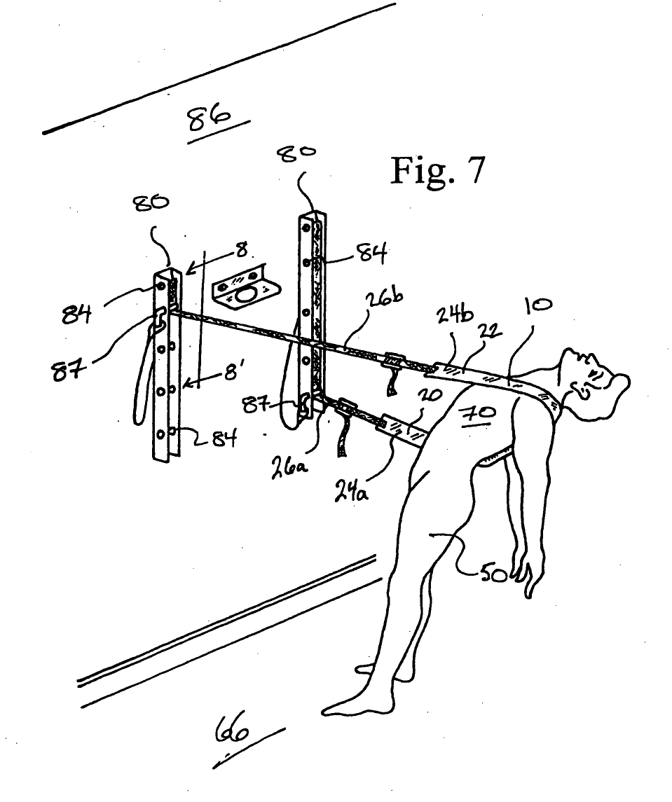

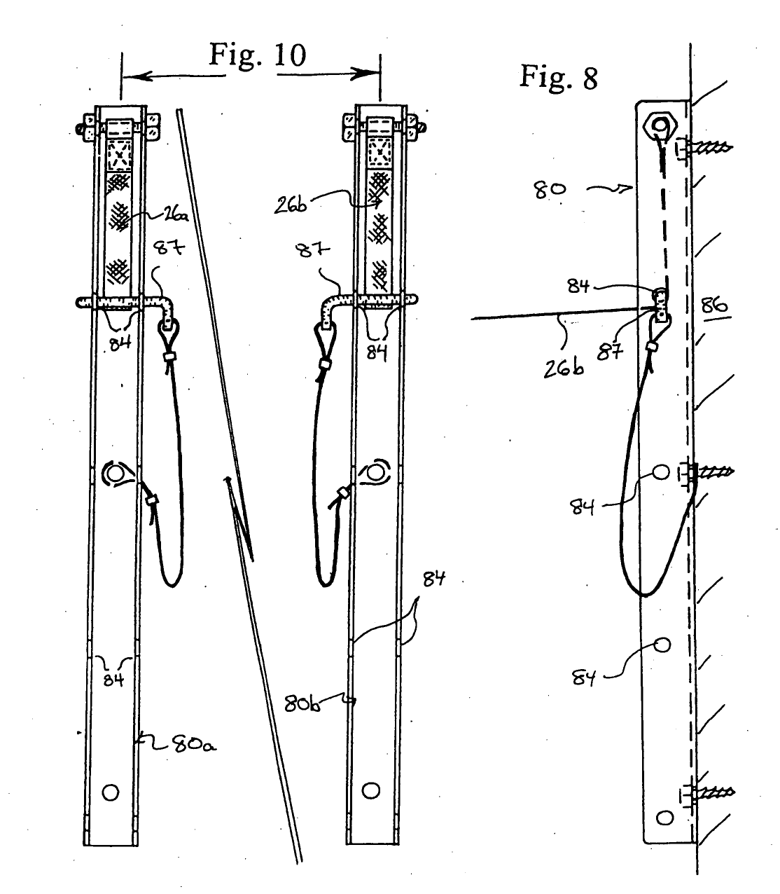

Although FIG. 6 illustrates the attachment of the apparatus 12 to a door 62 as a support in operation, the invention is not so limited. FIGS. 7 and 8 show an alternate possible construction in which like reference numerals are used to identify like components. In FIG. 7, the strap members 20, 22 of the physical therapy apparatus 10 are coupled to a respective permanent wall mounted support 80. Each wall mounted support 80 consists of an elongate square steel support channel which is provided with a series of longitudinally spaced aligned pairs of holes 84. Most preferably, each bracket 80 is secured to the wall 86 in a vertical orientation and at roughly the same height above the floor 66. A pin 87 is insertable through a selected pair of aligned pair of holes 84. The web ends 26a, 26b are shown best in FIG. 7 as being secured to an uppermost end of each respective channel support 80. As shown best in FIG. 8, the pin 87 is insertable through a selected pair of holes 84 to selectively vary the height at which each end of each strap member 20, 22 extend from the wall 86. It is to be appreciated that by selectively positioning the pin 87 of one or both support channels 80, the angle of attachment of apparatus 10 to the wall 86 may be varied, depending on the soft-tissues to be manipulated. The physical thereapy apparatus 10 of FIG. 7 may include a clip to permit the releasable attachment of the apparatus 10 to the support channels 80, however, in a more preferred construction, the flexible web strap ends 26a, 26b are permanently secured thereto.

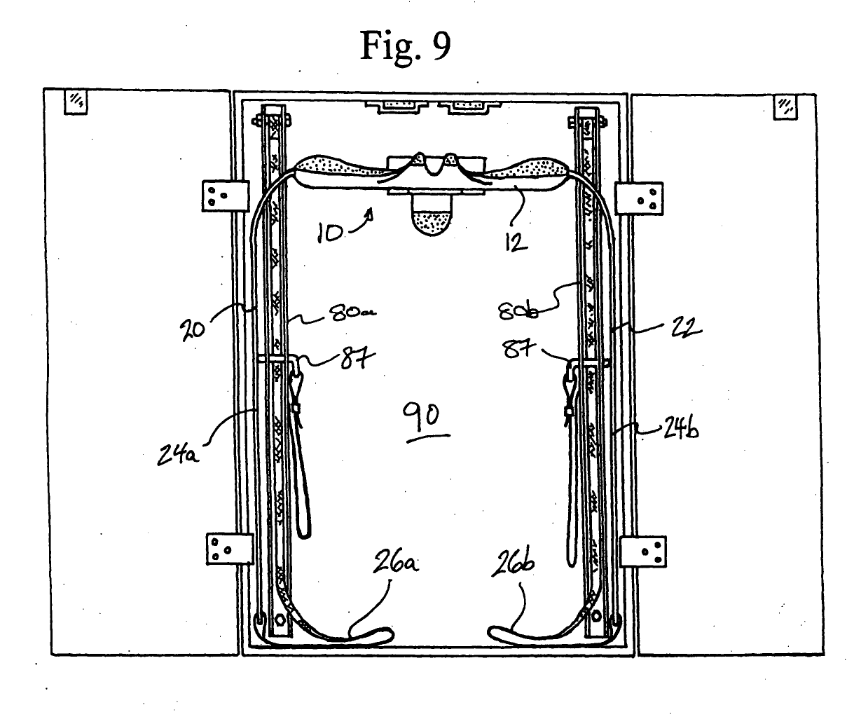

FIGS. 9 and 10 show an alternate embodiment of the physical therapy apparatus 10 in which like numerals are used to identify like components. FIG. 9 shows the physical therapy apparatus 10 as being housed within a wall mounted cabinet 90. A pair of vertically extending channel supports 80a, 80b, shown best in FIG. 10, are used in the attachment of the ends of the strap members 20, 22 thereto within the cabinet 90, as for example, in the identical manner shown in FIG. 8. In particular, as shown in FIG. 10, the apparatus 10 includes a pair of pins 87 which are insertable through a selected pair of aligned holes 84 formed horizontally through each channel support 80a, 80b to provide for adjustment in the height at which each strap 20, 22 extends from the cabinet 90.

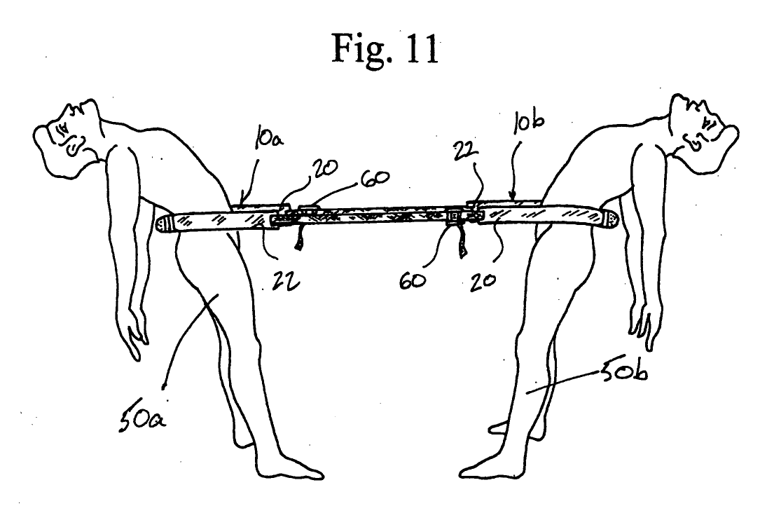

Although the preferred embodiments describe the attachment of the physical therapy apparatus 10 to a wall mounted channel support 80 or door 62, the invention is not so limited. FIG. 11 shows an alternate possible construction in which the strap members 20, 22 of two separate exercise apparatus 10a, 10b are coupled to each other in a mutually supporting arrangement for concurrent operation by two separate users 50a, 50b.

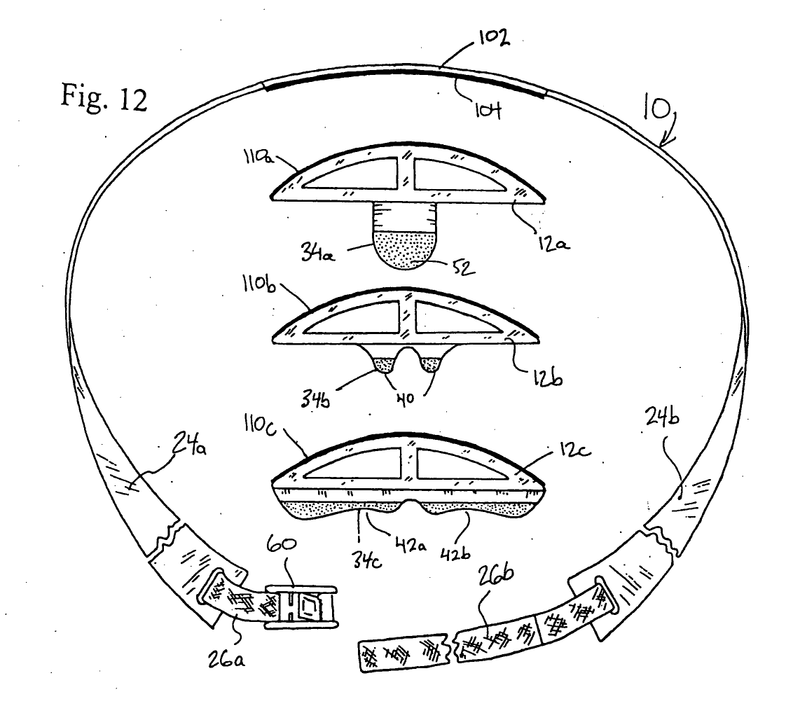

Similarly, although the preferred embodiment of the invention describes the exercise apparatus 10 as having a working member 12 with opposing operational surfaces, the invention is not so limited. Reference is made to FIG. 12 which shows an alternate construction for the physical therapy apparatus 10, in which like reference numerals are used to identify like components. In FIG. 12, the proximalmost ends of each of the strap members 20, 22 are secured to each other by a flexible connector 102 which carries a Velcro™ fastening strip 104 thereon.

The apparatus 10 further includes a series of three modular working members 12a, 12b, 12c. Each of the modular working members 12a, 12b, 12c has a respective longitudinally extending front operational surface 34a, 34b, 34c. The longitudinal rearward side 110a, 110b, 110c of each working members 12a, 12b, 12c remote from the operational side surface 34a, 34b, 34c is further provided with a Velcro™ fastening strip which is adapted for releasable engaging contact to the Velcro™ fastening strip 104 of the connector 102.

In use of the apparatus 10 shown in FIG. 12, the user 50 (FIG. 6) selectively attaches a chosen modular working member 12a, 12b, 12c depending upon the desired target soft-tissues to be manipulated. Once so chosen, the working member 12a, 12b, 12c is coupled to the strap members 20, 22 by pressing the Velcro™ fastening strip on the rearward side 110 of the member 12 against the connector fastening strip 104. The apparatus 10 is then coupled to a suitable support and used in a similar manner as that described with reference to FIGS. 1 to 5.

Although the preferred embodiment of the invention describes the use of threaded fasteners 58 as releasably coupling the working member 12 to the strap members 20, 22, the invention is not so limited. Other modes of coupling the strap members 20, 22 to the working member 12 are possible and will now become apparent including, without restriction, the use of snaps, clips, touch fasteners or other coupling devices. In an alternate embodiment, the semi-rigid portions 24a, 24b of the strap members 20, 22 and working member 12 could be integrally formed. In such a construction, the entire working member 12 and semi-rigid portions 24a, 24b could be molded or cast entirely of Nylon or other suitable semi-rigid plastic. In such case, the working member may be provided with an internal stiffener made of metal or other suitable material, therefore preventing excessive flexing of the working member.

Although the detailed description describes and illustrates various preferred embodiments, the invention is not so limited. Many modifications and variations will now occur to persons skilled in the art. For a definition of the invention, reference may be had to the appended claims.

I claim:

1. An apparatus for performing soft-tissue manipulation of a user's back and neck soft-tissues, the apparatus comprising,
a generally elongated working member extending from a first end portion to a second end portion and including a first longitudinally elongated surface, the first surface including first and second protuberances, each of said protuberances extending a first lateral direction from a remainder of said first surface, to a respective distal-most contact surface, the contact surfaces each being longitudinally spaced from a center of said member by a distance selected at between about 0.5 and 5 cm,
a pair of longitudinally elongated strap members, each said strap member having a first end coupled towards an associated one of said first and second end portions, and a second end adapted for coupling said apparatus to a support,
said working member and said strap members having an overall longitudial length selected to permit said user to effect relative contacting movement between said user's soft-tissues and the contact surface of said first and second protuberances, with said second ends of said strap members coupled to said support and said user standing in a generally rearwardly inclined position leaning in a direction away from said support.

2. The apparatus as claimed in claim 1 further including a coupling assembly for detachably coupling the working member to said pair of strap members.

3. The apparatus as claimed in claim 2 wherein said coupling assembly comprises a hook and loop-type fastener.

4. An apparatus as claimed in claim 1 wherein said working member further comprises a second longitudinally elongated surface, said second surface including a boss extending from a remainder of said second surface in a second lateral direction generally opposite to said first lateral direction to a distal-most semi-spherical surface.

5. The apparatus as claimed in claim 4 wherein said semi-spherical surface has a radius of curvature selected at between about 1 and 3 cm.

6. The apparatus as claimed in claim 4 wherein the contact surfaces of each of said first and second protuberances further include an elastomeric coating.

7. The apparatus as claimed in claim 1 wherein the support comprises a door, each of said strap members further include a generally planar strap portion having a thickness selected to permit the positioning of said strap portions interposed between said door and an adjacent door jamb, at least one of the strap members further including a connector for releasably securing the second ends of the strap members to each other in a position encircling said door.

8. The apparatus as claimed in claim 7 wherein each of said strap members further includes a semi-rigid portion intermediate said planar strap portion and said associated working member end portion, the semi-rigid portion having a rigidity selected to enable said user to reposition said working member vertically relative to said user's back by applying an upward or downward pressure thereon.

9. The apparatus as claimed in claim 1 wherein said support includes an elongated channel member having a length selected at between about 0.3 and 1.5 meters, and an anchor assembly for mounting said channel member in a generally vertically aligned orientation at a minimum height of between about 0.4 and 2 meters above ground.

10. The apparatus of claim 8 wherein said working member further includes a boss spaced towards said center of said massaging member, said boss extending a second lateral direction generally opposite to said first lateral direction to a generally semi-spherical end surface.

11. The apparatus of claim 8 wherein said working member and the semi-rigid portion of each of said strap members are integrally formed.

12. The apparatus of claim 1 wherein said first longitudinally elongated surface further comprises a pair of generally concave portions, each of said concave portions interposed respectively between said first protuberance and said first end portion, and said second protuberance and said second end portion.

13. The apparatus of claim 12 wherein each of said contact surfaces comprises a generally planar, laterally elongated surface, the contact surface of the first protuberance being spaced longitudinally from the contact surface of the second protuberance by a distance selected at between 1 and 5 cm.

14. The apparatus as claimed in claim 10 wherein said semi-spherical surface comprises a glutei soft-tissue stimulating member and further includes a resiliently deformable elastomeric layer.

15. The apparatus as claimed in claim 2 further including a generally elongated glutei soft-tissue stimulating member, said glutei soft-tissue stimulating member including a boss laterally extending laterally from a remainder of said stimulating member by a distance selected at between about 2 and 15 cm,
said coupling assembly cooperable with said glutei soft-tissue stimulating member to selectively permit its attachment to and detachment from said pair of strap members.

16. The apparatus as claimed in claim 2 further including a generally elongated back and neck soft-tissue stimulating member, said back and neck soft-tissue stimulating member including a centrally disposed recess extending laterally inwardly to a depth selected greater than about 1 cm,
said coupling assembly cooperable with said back and neck soft-tissue stimulating member to selectively permit its attachment to and detachment from said pair of strap members.

17. A physical therapy apparatus for performing soft-tissue manipulation of a user's back and neck soft-tissue, the apparatus containing,
a working member comprising a generally elongated member body extending from a first end portion to a second end portion, the body including,
a first operational side including first and second protuberances, each of said protuberances extending laterally outwardly from a remainder said first side to a respective distal-most contact surface, the contact surfaces being spaced from each other and a center portion of said body by a distance selected at between about 1 and 7.5 cm,
a second operational side including a boss, the boss being spaced towards said center portion and extending laterally outwardly from a remainder of said second side to a distal-most end,
first and second strap members, each of said strap members having a first end coupled towards an associated one of said first and second end portions, and a second end adapted for coupling said apparatus to an apparatus support, said working member and said first and second strap members having an overall length selected to permit said user to stand or sit in a generally rearwardly inclined position leaning in a direction away from said support and effect relative sliding contact between said user's back and neck soft-tissues and said body when the second ends of the strap members are coupled to said support.

18. The apparatus as claimed in claim 17 wherein each of the contact surfaces and said boss further include an elastomeric coating, and said first and second strap members further include a semi-rigid portion, the semi-rigid portion having sufficient rigidity to enable said user to reposition said working member vertically relative to said user's spine by applying a manual upward or downward pressure thereon while said user is in said generally rearwardly inclined position.

19. The apparatus of claim 18 wherein said first operational surface further comprising a pair of generally concave portions, each of said concave portions interposed between a respective one of said first and second protuberances and said first and second end portions.

20. A physical therapy apparatus for manipulating a user's neck, back and glutei soft tissues, the apparatus comprising,
a soft tissue manipulating member comprising a generally elongated member body extending from a first end portion to a second end portion, the body including,
a first operational side including first and second protuberances, each of said protuberances extending in laterally outwardly from a remainder said first side to a respective distal-most contact surface, the contact surfaces comprising a laterally elongated surface and being spaced from each other and a center portion of said body by a distance selected at between about 1 and 7.5 cm,
said first operational side further comprising a pair of generally concave portions, each of said concave portions interposed between a respective one of said first and second protuberances and said first and second end portions,
a second operational side including a boss, the boss being spaced towards said center portion and extending laterally outwardly from a remainder of said second side to a distal-most end, said distal-most end comprising semi-spherical surface and further includes a resiliently deformable elastomeric layer,
first and second strap members, each of said strap members having a first end coupled towards an associated one of said first and second end portions, and a second end adapted for coupling said apparatus to an apparatus support, said soft tissue manipulating member and said first and second strap members having an overall length selected to permit said user to stand in a generally rearwardly inclined position leaning in a direction away from said support and effect relative sliding contact between said user's back muscles and said body when the second ends of the strap members are coupled to said support.

21. The apparatus as claimed in claim 20 wherein said apparatus support is selected from the group consisting of a door, a second physical therapy apparatus and a wall mounted channel member.
